(19) United States
(12) Patent Application Publication
(10) Pub. No.: US 2020/0328806 A1
(43) Pub. Date: Oct. 15, 2020

(54) MEASUREMENT DEVICE, TRANSMISSION DEVICE, AND NETWORK SYSTEM

(71) Applicant: FUJITSU LIMITED, Kawasaki-shi (JP)

(72) Inventors: Makoto SHIMIZU, Oyama (JP); Naoki AINAKA, Kawasaki (JP); Kenji Ota, Ota (JP)

(73) Assignee: FUJITSU LIMITED, Kawasaki-shi (JP)

(21) Appl. No.: 16/816,378

(22) Filed: Mar. 12, 2020

(30) Foreign Application Priority Data
Apr. 12, 2019 (JP) 2019-076332

(51) Int. Cl. H04B 10/079

(52) U.S. Cl. CPC H04B 10/0791

(57) ABSTRACT

A measurement device includes a memory, and circuitry coupled to the memory and configured to obtain first time stamp information transmitted from the first transmission device and added to a first frame in which an error has occurred in the transmission line, obtain second time stamp information transmitted from the second transmission device and added to a second frame in which an error has occurred in the transmission line, and specifies the error occurrence position in the transmission line on the basis of the first time stamp information, the second time stamp information, and a light speed, wherein the first time stamp information is added to the first frame by the first transmission device in time synchronization with the second transmission device, and the second time stamp information is added to the second frame by the second transmission device in time synchronization with the first transmission device.

### CROSS-REFERENCE TO RELATED APPLICATION

This application is based upon and claims the benefit of priority of the prior Japanese Patent Application No. 2019-76332, filed on Apr. 12, 2019, the entire contents of which are incorporated herein by reference.

### FIELD

The embodiment discussed herein is related to a measurement device, a transmission device, and a network system.

### BACKGROUND

According to the digital coherent transmission scheme, polarized light is modulated with data having been subject to multilevel modulation, and polarized beams of light having different directions of polarization are multiplexed and transmitted. A state of polarization (SOP) of the polarized light varies due to a phase cycle or slippage caused by a lightning strike on an optical fiber, vibration of the optical fiber, or the like. The variation of the SOP causes a bursty error of data signals. Such occurrence of an error becomes more remarkable as the degree of the multilevel modulation increases to increase the transmission capacity.

Therefore, it has been desirable to specify a fault position of an optical transmission line at which the error has occurred and to analyze the cause. With regard to specifying the fault position, there has been described a technique of specifying a fault point of a multi-branched optical line.

For example, Japanese Laid-open Patent Publication No. 2001-21445 and the like have been disclosed as a related art.

### SUMMARY

According to an aspect of the embodiments, a measurement device includes a memory, and circuitry coupled to the memory and configured to obtain first time stamp information transmitted from the first transmission device and added to a first frame in which an error has occurred in the transmission line, obtain second time stamp information transmitted from the second transmission device and added to a second frame in which an error has occurred in the transmission line, and specifies the error occurrence position in the transmission line on the basis of the first time stamp information, the second time stamp information, and a light speed, wherein the first time stamp information is added to the first frame by the first transmission device in time synchronization with the second transmission device, and the second time stamp information is added to the second frame by the second transmission device in time synchronization with the first transmission device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram illustrating an exemplary network system;

FIG. 2 is a diagram illustrating exemplary operation of a transponder;

FIG. 3 is a diagram illustrating a state of frame transmission for each time;

FIG. 4 is a diagram illustrating an exemplary frame format;

FIG. 5 is a configuration diagram illustrating exemplary transponders;

FIG. 6 is a diagram illustrating an exemplary method of specifying a transmission time;

FIG. 7 is a configuration diagram illustrating an exemplary monitoring controller;

FIG. 8 is a flowchart illustrating an exemplary process of frame transmission;

FIG. 9 is a flowchart illustrating an exemplary process of frame reception;

FIG. 10 is a flowchart illustrating an exemplary process of measuring a fault position;

FIG. 11 is a diagram illustrating operation of transponders according to another example;

FIG. 12 is a configuration diagram illustrating a transponder according to another example;

FIG. 13 is a configuration diagram illustrating a transponder according to another example;

FIG. 14 is a flowchart illustrating an exemplary process of frame reception performed by a transponder according to another example; and

FIG. 15 is a flowchart illustrating an exemplary process of frame reception performed by a transponder according to another example.

### DESCRIPTION OF EMBODIMENTS

Since state variation of polarized light converges in a short period of time, it is difficult to specify a fault position from a pulse waveform incident on an optical transmission line as in the related art, and it takes a huge amount of time and effort to specify the fault position.

In view of the above, it is an object of the present embodiment to provide a measurement device, a transmission device, and a network system capable of easily measuring a fault position of an optical transmission line.

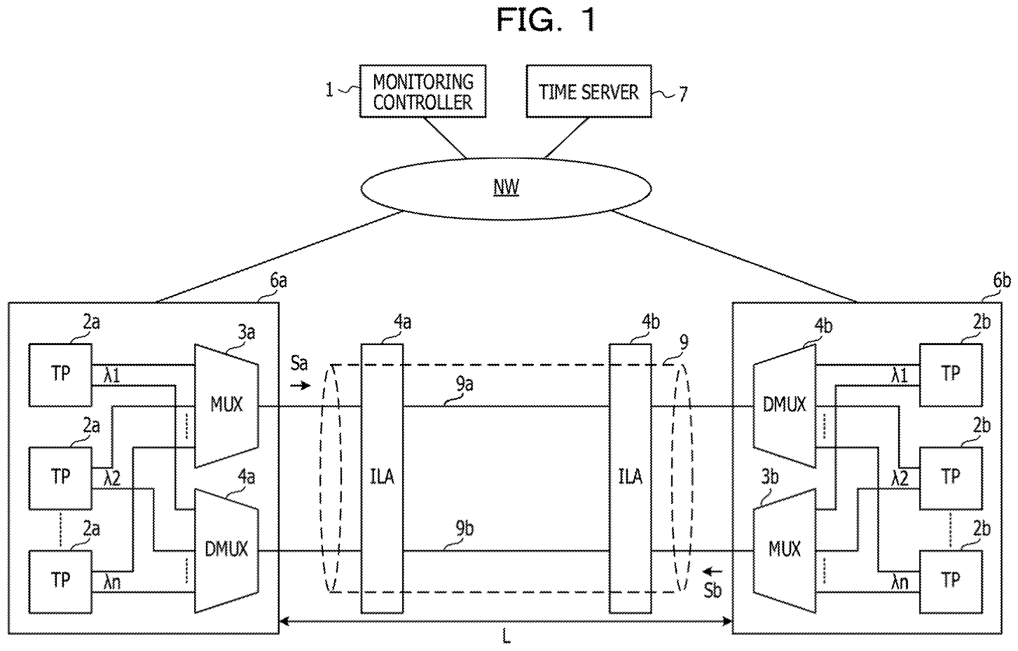

FIG. 1 is a configuration diagram illustrating an exemplary network system. The network system includes a monitoring controller 1, in-line amplifiers (ILAs) 4a and 4b, wavelength multiplexing devices 6a and 6b, and a time server 7.

The wavelength multiplexing devices 6a and 6b are connected to each other via an optical transmission line 9. The optical transmission line 9 is, for example, a multicore fiber, and includes two optical fibers 9a and 9b. One of the wavelength multiplexing devices transmits wavelength multiplex optical signals Sa to another wavelength multiplexing device 6b via the optical fiber 9a, and the other wavelength multiplexing device 6b transmits wavelength multiplex optical signals Sb to the wavelength multiplexing device 6a via the optical fiber 9b. Note that a distance L of the optical transmission line 9 between the wavelength multiplexing devices 6a and 6b is, for example, 800 (km).

With this arrangement, the wavelength multiplexing devices 6a and 6b exchange the wavelength multiplex optical signals Sa and Sb via the optical transmission line 9. Here, the transmission speeds of the wavelength multiplex optical signals Sa and Sb are the same (e.g., 100 (Gbps) to 400 (Gbps)).

The wavelength multiplexing devices 6a and 6b respectively generate the wavelength multiplex optical signals Sa and Sb by multiplexing wavelengths of optical signals having wavelengths of λ1 to λn. The wavelength multiplexing devices 6a and 6b Includes a plurality of transponders (TPs) 2a and 2b, multiplexers (MUXs) 3a and 3b, and demultiplexers (DMUXs) 4a and 4b.

The transponders 2a and 2b are examples of the transmission device, which generate polarized multiplex optical signals having wavelengths of λ1 to λn Including continuous frames, and output the signals to the multiplexers 3a and 3b. The multiplexers 3a and 3b are, for example, optical couplers, which multiplex the polarized multiplex optical signals having wavelengths of λ1 to λn to generate the wavelength multiplex optical signals Sa and Sb, respectively.

The wavelength multiplex optical signals Sa and Sb are output to the optical transmission line 9. The ILAs 4a and 4b are connected to the optical transmission line 9. The ILAs 4a and 4b amplify the wavelength multiplex optical signals Sa and Sb.

The wavelength multiplex optical signals Sa and Sb are input from the optical transmission line 9 to the demultiplexers 4b and 4a of the wavelength multiplexing devices 6b and 6a, respectively. The demultiplexers 4b and 4a are, for example, optical splitters, which demultiplex the wavelength multiplex optical signals Sa and Sb into each of polarized multiplex optical signals having wavelengths of λ1 to λn in wavelength units. Each of the polarized multiplex optical signals having wavelengths of λ1 to λn is received by the transponders 2b and 2a as transmission destination.

The monitoring controller 1 and the time server 7 communicate with the wavelength multiplexing devices 6a and 6b via a management network NW. The monitoring controller 1 is, for example, a network operation system (OpS), which monitors and controls the wavelength multiplexing devices 6a and 6b. The monitoring controller 1 is an example of the measurement device, which obtains, from each of the transponders 2a and 2b, transmission time of a frame in which an error has occurred (hereinafter referred to as “error frame”), and measures a fault position of the optical transmission line 9 from each transmission time.

The time server 7 distributes time information to the transponders 2a and 2b using, for example, a precision time protocol (PTP). As a result, the transponders 2a and 2b can be in time synchronization with the time server 7 and add transmission time to the frame to be transmitted.

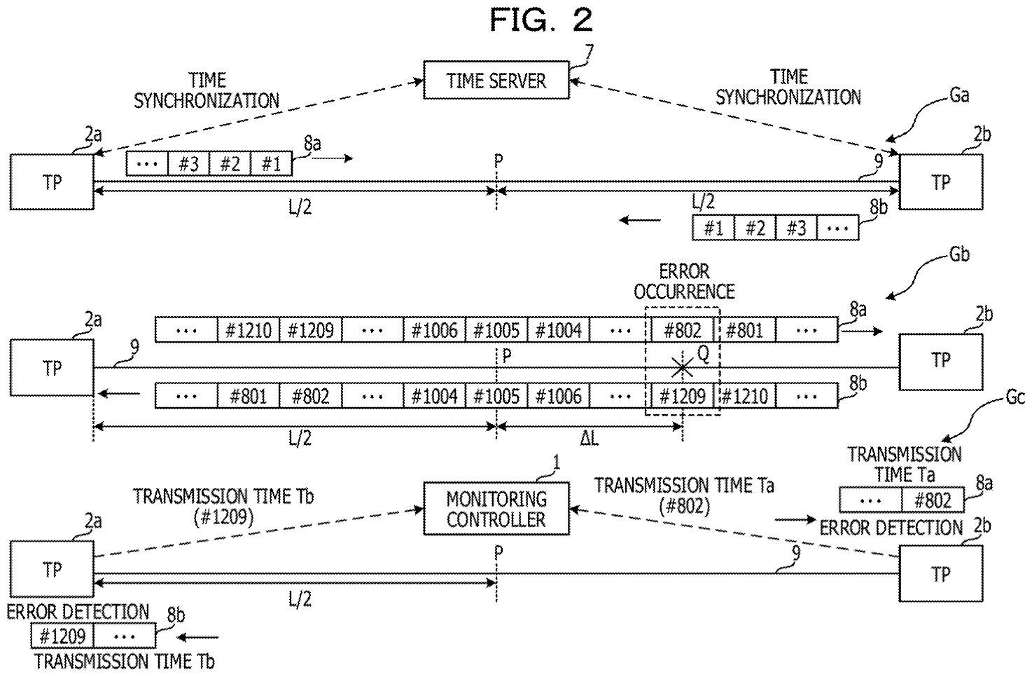

FIG. 2 is a diagram illustrating exemplary operation of the transponders 2a and 2b. The transponder 2a successively transmits a plurality of frames 8a to the transponder 2b, and the transponder 2b successively transmits a plurality of frames 8b to the transponder 2a. Note that the frames 8a and 8b are examples of a first frame and a second frame.

A reference sign Ga indicates a state in which the transponders 2a and 2b have started to transmit frames. The transponders 2a and 2b are periodically subject to time synchronization with the time server 7, for example, and add transmission time to each of the frames 8a and 8b to be transmitted. The transmission time is added to the overhead of each of the frames 8a and 8b as a time stamp “#1”, “#2”, or “#3”, for example. Note that a reference sign P indicates the intermediate position of the optical transmission line 9, that is, for example, a position separated by a distance L/2 from each of the transponders 2a and 2b.

A reference sign Gb indicates a state in which an error has occurred in the frames 8a and 8b due to a failure in the optical transmission line 9. Since the transponders 2a and 2b are in time synchronization with the time server 7, they simultaneously transmit the frames 8a and 8b to which the same time stamps are added, respectively. Accordingly, the frames 8a and 8b having the same time stamp (“#1005” in this example) usually pass through the intermediate position P of the optical transmission line 9.

For example, it is assumed that a failure in the optical transmission line 9 has occurred at a position Q, which is a distance ΔL away from the intermediate position P on the side of the transponder 2b, and an error has occurred in the frame 8a of the time stamp “#802” and the frame 8b of the time stamp “#1209” passing through the position Q. Here, examples of the failure in the optical transmission line 9 include a lightning strike on the optical transmission line 9 and vibration of the optical transmission line 9, which indicate a failure that causes a bursty error in the frames 8a and 8b on the basis of polarization state variation of the polarized light of the optical signals.

A reference sign Gc indicates a state in which the transponders 2a and 2b have received the error frames 8a and 8b. The transponder 2b receives the frame 8a with the time stamp “#802” transmitted from the other transponder 2a, and detects an error. The transponder 2b transmits the time stamp “#802” to the monitoring controller 1 as transmission time Ta of the frame 8a in which the error has been detected.

The transponder 2a receives the frame 8b with the time stamp “#1209” transmitted from the other transponder 2b, and detects an error. The transponder 2a transmits the time stamp “#1209” to the monitoring controller 1 as transmission time Tb of the frame 8b in which the error has been detected.

The monitoring controller 1 measures, from the multiplied value of the difference between the transmission times Ta and Tb and a light speed Vc, the position Q (hereinafter referred to as “fault position Q”) of the optical transmission line 9 at which the error has occurred in the frames 8a and 8b.

ΔL=(Tb−Ta)×Vc/2 (1)

Lq=L/2+ΔL (2)

The monitoring controller 1 calculates, using the formula (1) set out above, the distance ΔL between the fault position Q and the intermediate position P on the side of the transponder 2b. The monitoring controller 1 calculates, using the formula (2) set out above, the distance Lq between the transponder 2a and the fault position Q from the distance L and the distance ΔL of the optical transmission line 9.

As described above, since the transponders 2a and 2b have the same transmission speed and are in time synchronization with the time server 7, the time stamp “# x” (x: transmission time) of the frames 8a and 8b passing through the intermediate position P of the optical transmission line 9 is the same at all times. Accordingly, each of the value obtained by multiplying, by the light speed Vc, the difference (x−Ta) between the transmission time x and the transmission time Ta indicated by the time stamp added to the error frame 8a, and the value obtained by multiplying, by the light speed Vc, the distance (Tb−x) between the transmission time x and the transmission time Tb indicated by the time stamp added to the error frame 8b corresponds to the distance ΔL.

Therefore, the value ((Tb−Ta)×Vc) obtained by multiplying, by the light speed Vc, the sum (Tb−Ta) of the difference (x−Ta) between the transmission time Ta and the transmission time x and the difference (Tb−x) between the transmission time Tb and the transmission time x is twice the distance ΔL. Accordingly, the distance Lq between the transponder 2a and the fault position Q is calculated using the formula (1).

ΔL=(Ta−Tb)×Vc/2 (3)

Furthermore, in a case where the distance ΔL between the fault position Q and the intermediate position P on the side of the transponder 2a is calculated using the formula (3) set out above, the monitoring controller 1 can calculate the distance Lq between the other transponder 2b and the fault position Q using the formula (2) set out above.

Furthermore, while a constant value such as the light speed in a vacuum may be used as the light speed Vc, for example, it is possible to calculate, by using the propagation speed of light in the optical transmission line (e.g., 2.0×10⁸ (m/s)), the distance Lq of the fault position Q with higher accuracy while suppressing an error.

In the example of FIG. 2, the transmission time Ta corresponds to the time stamp “#802” (802 (μs)), and the transmission time Tb corresponds to the time stamp “#1209” (1209 (μs)). Here, the distance L of the optical transmission line 9 is set to 800 (km), and the light speed Vc is set to 2.0×10⁸ (m/s).

At this time, the distance ΔL between the fault position Q and the intermediate position P is calculated to be 81.2 (km) (=(1208−802)×10×2.0×10⁸/2) using the formula (1). Therefore, the distance Lq of the fault position Q from the transponder 2a is calculated to be 440.6 (km) (=800/2+81.2) using the formula (2).

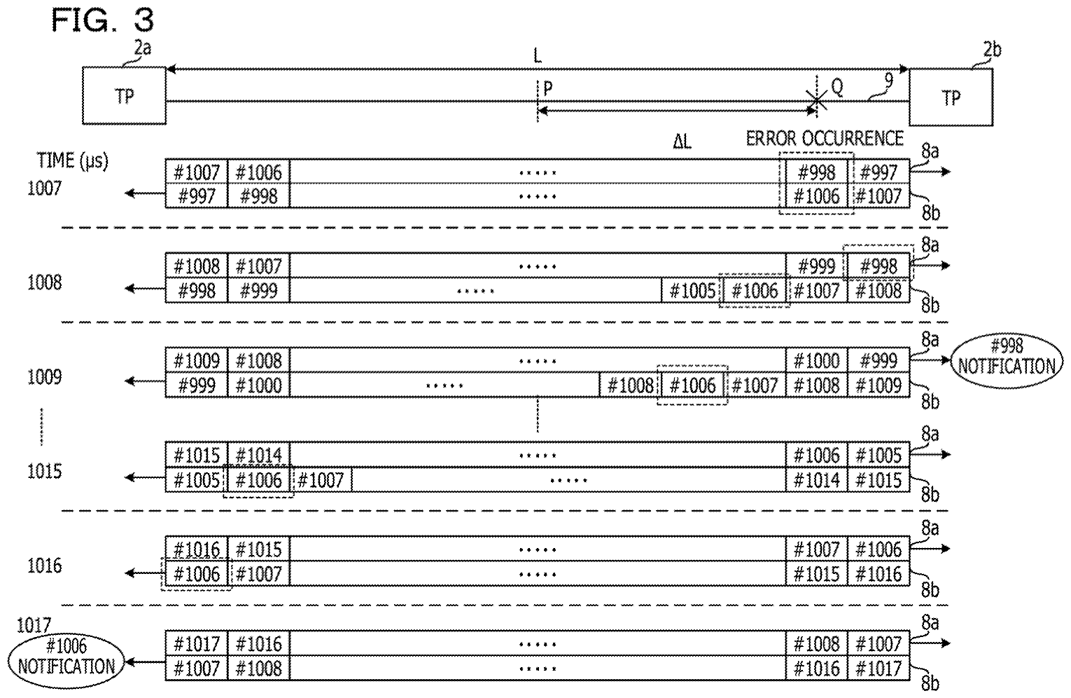

FIG. 3 is a diagram illustrating a state of transmission of the frames 8a and 8b for each time. FIG. 3 illustrates the frames 8a and 8b at time 1007 (μs), 1008 (μs), 1009 (μs), 1015 (μs), 1016 (μs), and 1017 (μs) in the period from the time 1007 to 1017 (μs). Furthermore, a required time for the transponders 2a and 2b to transmit one frame 8a and 8b is assumed to be 1 (μs).

At the time 1007 (μs), an error occurs in the frame 8a with the time stamp “#998” and the frame 8b with the time stamp “#1006” passing through the fault position Q. At the time 1008 (μs), the transponders 2a and 2b receive the frames 8a and 8b with the time stamp “#999”, respectively.

At the time 1009 (μs), the transponders 2a and 2b receive the frames 8a and 8b with the time stamp “#998”, respectively. At this time, the transponder 2b detects an error in the received frame 8a, and discards the frame 8a.

Accordingly, the transponder 2b fails to detect the time stamp “#998” from the error frame 8a. However, since the frame 8a is not in burst transmission but is transmitted successively, the transponder 2b can identify the time stamp “#998” of the error frame 8a from the time stamp “#997” of the frame 8a received immediately before the error frame 8a. The transponder 2b notifies the monitoring controller 1 of the time stamp “#998” as the transmission time Ta.

Thereafter, at the time 1015 (μs), the transponders 2a and 2b receive the frames 8a and 8b with the time stamp “#1004”, respectively. Next, at the time 1016 (μs), the transponders 2a and 2b receive the frames 8a and 8b with the time stamp “#1005”, respectively.

Next, at the time 1017 (μs), the transponders 2a and 2b receive the frames 8a and 8b with the time stamp “#1006”, respectively. At this time, the transponder 2a detects an error in the received frame 8b, and discards the frame 8b.

In a similar manner to the transponder 2b, the transponder 2a can identify the time stamp “#1006” of the frame 8b from the time stamp “#1005” of the frame 8b received immediately before the error frame 8b. The transponder 2b notifies the monitoring controller 1 of the time stamp “#1006” as the transmission time Tb.

In the present example, the transmission time Ta corresponds to the time stamp “#998” (998 (μs)), and the transmission time Tb corresponds to the time stamp “#1006” (1006 (μs)). Here, the distance L of the optical transmission line 9 is set to 2200 (km), and the light speed Vc is set to 2.0×10⁸ (m/s).

At this time, the distance ΔL between the fault position Q and the intermediate position P on the side of the transponder 2b is calculated to be 800 (km) (=(1006−998)×10⁶×2.0×10⁸/2) using the formula (1). Therefore, the distance Lq of the fault position Q from the transponder 2a is calculated to be 1900 km (=2200/2+800) using the formula (2).

Note that the distance ΔL between the fault position Q and the intermediate position P on the side of the transponder 2a is calculated to be −800 (km) (=(998−1006)×10⁶×2.0×10⁶/2) using the formula (3) described above. Therefore, the distance Lq of the fault position Q from the transponder 2b is calculated to be 300 (km) (=2200/2−800) using the formula (2).

In this manner, the monitoring controller 1 measures the fault position Q of the optical transmission line 9 at which an error has occurred in the frames 8a and 8b from the multiplied value of the light speed Vc and the transmission times Ta and Tb respectively obtained from the transponders 2a and 2b. Accordingly, the monitoring controller 1 can easily measure the fault position Q of the optical transmission line 9 without taking much time and effort.

The transponders 2a and 2b calculate the distance Lq of the fault position Q in units of a distance corresponding to the required time for transmitting one frame 8a and 8b to add a time stamp to each of the frames 8a and 8b. In the present example, since the required time for transmitting one frame 8a and 8b is 1 (μs), the distance Lq of the fault position Q is calculated in units of 200 (m), which is a moving distance of 1 (μs) of the light speed Vc. Accordingly, accuracy in calculating the distance Lq of the fault position Q is dependent on the type and transmission speed of the frames 8a and 8b.

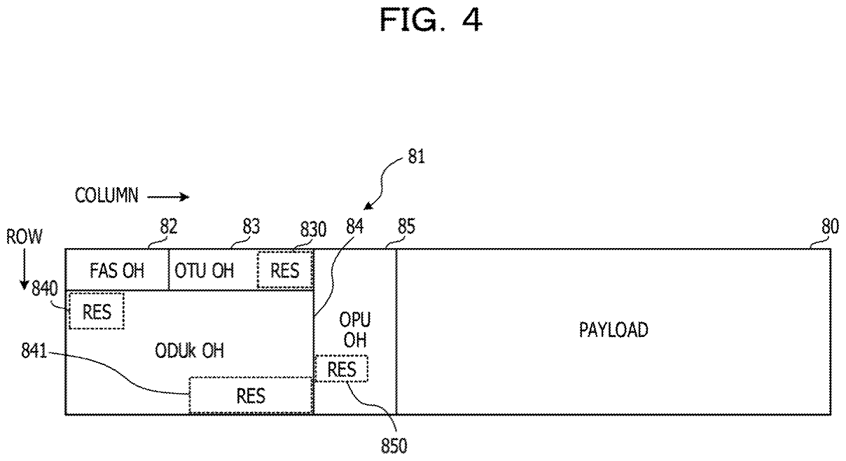

FIG. 4 is a diagram illustrating an example of the format of the frames 8a and 8b. While examples of the frames 8a and 8b include an optical transport unit (OTU) frame defined in Recommendation G. 709 of international Telecommunication Union Telecommunication Standardization Sector (ITU-T) in the present example, it is not limited thereto.

The frames 8a and 8b include an overhead 81 and a payload 80. The payload 80 contains data of client signals, such as Ethernet (registered trademark, the same applies hereinafter) signals, for example.

The overhead 81 includes a frame alignment signal overhead (FAS OH) 82, an OTU OH 83, an optical data unit-k overhead (ODUk OH) 84, and an optical payload unit overhead (OPU OH) 85. Note that the details of the overhead 81 are defined in ITU-T Recommendation G. 709.

The transponders 2a and 2b add the transmission time of the frames 8a and 8b to, for example, a reserve area 830 in the OTU OH 83, reserve areas 840 and 841 in the ODUk OH 84, or a reserve area 850 in the OPU OH 85. Accordingly, the transponders 2a and 2b can add the transmission time to the frames 8a and 8b without reducing the data band in the payload 80. Note that the reserve areas 830, 840, 841, and 850 are areas whose uses are not defined in ITU-T Recommendation G. 709.

Next, a configuration of the transponders 2a and 2b will be described.

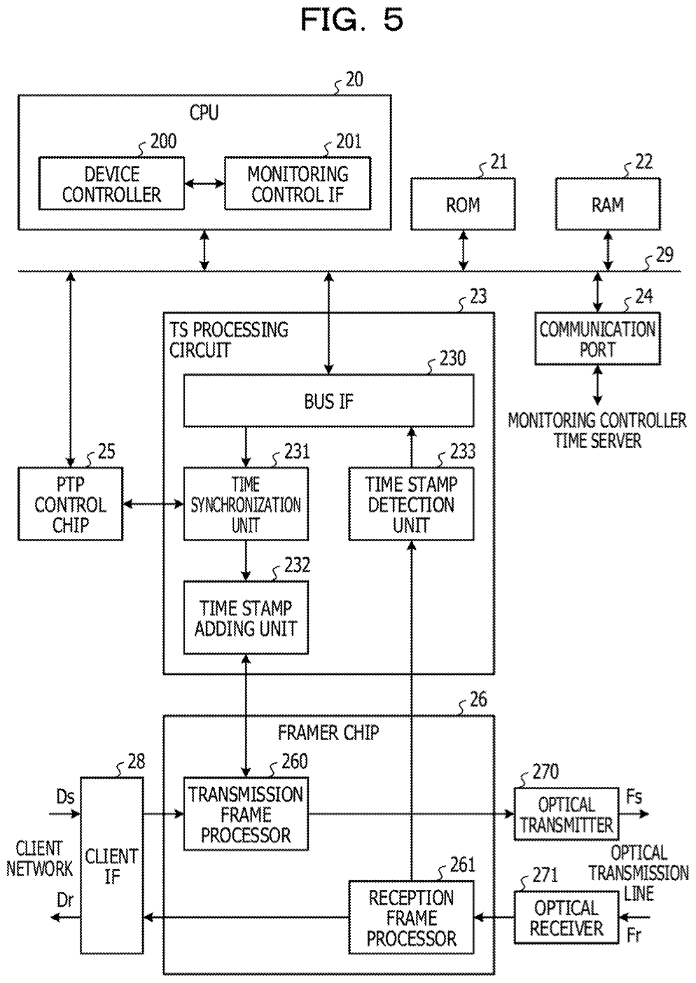

FIG. 5 is a configuration diagram illustrating an example of the transponders 2a and 2b. The transponders 2a and 2b include a central processing unit (CPU) 20, a read only memory (ROM) 21, a random access memory (RAM) 22, a time stamp (TS) processing circuit 23, a communication port 24, and a PTP control chip 25.

Furthermore, the transponders 2a and 2b further include a client interface (client IF) 28, a framer chip 26, an optical transmitter 270, and an optical receiver 271. Note that the TS processing circuit 23, the PTP control chip 25, the framer chip 26, and the client IF 28 are circuits including hardware such as a field programmable gate array (FPGA) and an application-specific integrated circuit (ASIC). Note that the function of the TS processing circuit 23 may be implemented by software as a function of the CPU 20.

The framer chip 26 includes a transmission frame processor 260 and a reception frame processor 261, and is connected to the TS processing circuit 23, the optical transmitter 270, the optical receiver 271, and the client IF 28.

The client IF 28 receives client signals Ds from a client network and outputs the signals to the transmission frame processor 260. The transmission frame processor 260 stores data of the client signals Ds in the payload 80 of the frames 8a and 8b, and generates the overhead 81 to add it to the payload 80. The transmission frame processor 260 further stores the time stamp input from the TS processing circuit 23 in predetermined reserve areas 830, 840, 841, and 850 in the overhead 81. The transmission frame processor 260 outputs the frames 8a and 8b to the optical transmitter 270.

The optical transmitter 270 transmits the frame 8a to the other transponders 2a and 2b via the optical transmission line 9 at a predetermined transmission speed in accordance with, for example, a digital coherent transmission scheme. The optical transmitter 270 includes a transmission light source such as a laser diode (LD), a polarization beam splitter, a polarization beam combiner, a modulator of multilevel modulation such as 16 quadrature amplitude modulation (QAM), an optical modulator, and the like. The optical transmitter 270 converts the frames 8a and 8b into polarized multiplex optical signals Fs and transmits the signals. The polarized multiplex optical signals Fs are input to the optical transmission line 9 from the multiplexers 3a and 3b. Note that the optical transmitter 270 is an example of a first transmission unit and a second transmission unit.

Furthermore, the optical receiver 271 receives the frame 8a and 8b transmitted from the other transponders 2a and 2b via the optical transmission line 9 at a predetermined transmission speed in accordance with, for example, a digital coherent transmission scheme. The optical receiver 271 includes a local light source such as an LD, a polarization beam splitter, a polarization beam combiner, a demodulator of multilevel modulation such as 16QAM, a photodiode, and the like. The optical receiver 271 converts polarized multiplex optical signals Fr input from the demultiplexers 4a and 4b into the frames 8a and 8b of electric signals, and outputs the frames to the reception frame processor 261. Note that the optical receiver 271 is an example of a first reception unit and a second reception unit.

The reception frame processor 261 converts the frames 8a and 8b into client signals Dr, and outputs the signals to the client IF 28. The client IF 28 transmits the client signals Dr to the client network.

Furthermore, the reception frame processor 261 obtains a time stamp from the frames 8a and 8b, and outputs the time stamp to the TS processing circuit 23. Here, the reception frame processor 261 detects an error in the frames 8a and 8b, and discards the error frames 8a and 8b. At this time, since the reception frame processor 261 fails to obtain the time stamp, it outputs detection signals indicating the detection of the error to the TS processing circuit 23.

The TS processing circuit 23 includes a bus interface (bus IF) 230, a time synchronization unit 231, a time stamp adding unit 232, and a time stamp detection unit 233. The bus IF 230 relays communication among the time synchronization unit 231, the time stamp detection unit 233, and the CPU 20 via the bus 29.

The time synchronization unit 231 periodically performs time synchronization processing with the time server 7 in accordance with a command from the CPU 20, for example. At this time, the PTP control chip 25 communicates with the time server 7 via the communication port 24 on the basis of the PTP. The time synchronization unit 231 obtains highly accurate time from the time server 7 through communication of the PTP control chip 25.

The time stamp adding unit 232 is an example of a first adding unit and a second adding unit, and adds transmission time to the frames 8a and 8b. The time stamp adding unit 232 receives, from the transmission frame processor 260, notification indicating that the frames 8a and 8b to be transmitted are generated. The time stamp adding unit 232 obtains time from the time synchronization unit 231 in response to the notification of generation of the frames 8a and 8b to generate a time stamp. The time stamp adding unit 232 outputs the time stamp to the transmission frame processor 260.

The transmission frame processor 260 inserts the time stamp into the overhead 81 of the frames 8a and 8b. Accordingly, the time at which the transmission frame processor 260 transmits the frames 8a and 8b is added to the frames 8a and 8b.

Furthermore, in a case where the reception frame processor 261 detects and discards normal frames 8a and 8b, the time stamp detection unit 233 obtains the time stamp of the frames 8a and 8b from the reception frame processor 261. Furthermore, in a case where the reception frame processor 261 detects and discards error frames 8a and 8b, the time stamp detection unit 233 receives detection signals of the error of the frames 8a and 8b from the reception frame processor 261.

The time stamp detection unit 233 specifies the transmission time of the error frames 8a and 8b in response to the reception of the detection signals, and outputs the transmission time to the CPU 20 via the bus.

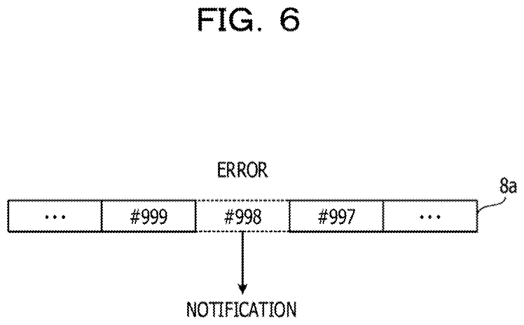

FIG. 6 is a diagram illustrating an exemplary method of specifying a transmission time. The time stamp detection unit 233 holds the time stamp obtained from the reception frame processor 261, and specifies the transmission time on the basis of the time stamp of the frames 8a and 8b immediately before the error frames 8a and 8b.

For example, in a case where an error is detected in the frame 8a with the time stamp “#998”, the time stamp detection unit 233 specifies the transmission time “998” from the time stamp “#997” of the immediately preceding normal frame 8a. The time stamp detection unit 233 outputs the specified transmission time to the CPU 20.

Referring again to FIG. 5, the CPU 20 is connected to the ROM 21, the RAM 22, the TS processing circuit 23, the communication port 24, and the PTP control chip 25 via the bus 29.

The ROM 21 stores a program for driving the CPU 20. The RAM 22 functions as a working memory of the CPU 20. The communication port 24 is, for example, a local area network (LAN) port, and relays communication among the CPU 20, the monitoring controller 1, and the time server 7 via the management network NW.

When reading the program from the ROM 21, the CPU 20 forms a device controller 200 and a monitoring control interface (monitoring control IF) 201 as functions. The monitoring control IF 201 communicates with the monitoring controller 1 and the time server 7 via the communication port 24.

The device controller 200 controls operation of the transponders 2a and 2b. The device controller 200 instructs, via the bus 29, the time synchronization unit 231 to perform time synchronization.

Furthermore, the device controller 200 obtains the transmission time of the error frames 8a and 8b from the time stamp detection unit 233 via the bus 29. The device controller 200 outputs the transmission time to the monitoring control IF 201. The monitoring control IF 201 notifies the monitoring controller 1 of the transmission time. Note that the monitoring control IF 201 is an example of a notification unit.

Next, a configuration of the monitoring controller 1 will be described.

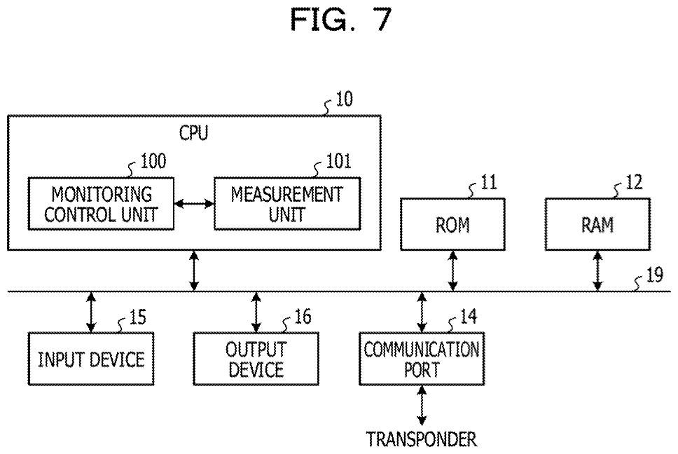

FIG. 7 is a configuration diagram illustrating an example of the monitoring controller 1. The monitoring controller 1 includes a CPU 10, a ROM 11, a RAM 12, a communication port 14, an input device 15, and an output device 16. The CPU 10 is connected to, via a bus 19, the ROM 11, the RAM 12, the communication port 14, the input device 15, and the output device 16 in such a manner that signals can be input to and output from each other.

The ROM 11 stores a program for driving the CPU 10. The RAM 12 functions as a working memory of the CPU 10. The communication port 14 is, for example, a wireless local area network (LAN) card or a network interface card (NIC), which processes communication between the CPU 10 and the transponders 2a and 2b.

The input device 15 is a device for inputting information. Examples of the input device 15 include a keyboard, a mouse, and a touch panel. The input device 15 outputs the input information to the CPU 10 via the bus 19.

The output device 16 is a device for outputting information. Examples of the output device 16 include a display and a touch panel. The output device 16 obtains information from the CPU 10 via the bus 19, and outputs the information.

When reading the program from the ROM 11, the CPU 10 forms a monitoring control unit 100 and a measurement unit 101 as functions. The monitoring control unit 100 communicates with the transponders 2a and 2b via the communication port 14 to monitor and control the wavelength multiplexing devices 6a and 6b. The monitoring control unit 100 obtains the transmission times Tb and Ta of the frames 8b and 8a from the transponders 2a and 2b, respectively. Note that the monitoring control unit 100 is an example of an acquisition unit, and the transmission times Tb and Ta are examples of a first transmission time and a second transmission time.

Furthermore, the measurement unit 101 measures the fault position Q of the optical transmission line 9 at which the error of the frames 8a and 8b has occurred from the multiplied value of the difference between the transmission times Tb and Ta and the light speed Vc. Note that a method of measurement is as described using the formulae (1) to (3) described above.

The measurement unit 101 outputs the fault position Q to the output device 16 in response to operational input from the input device 15, for example. As a result, a user can know the fault position Q accordingly.

Next, a transmission process and a reception process of the frames 8a and 8b performed by the transponders 2a and 2b will be described.

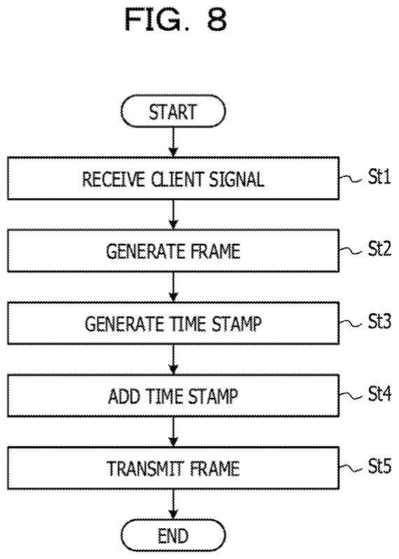

FIG. 8 is a flowchart illustrating an example of the transmission process of the frames 8a and 8b. The client IF 28 receives the client signals Ds from the client network (step St1) The client signals Ds are output to the transmission frame processor 260.

Next, the transmission frame processor 260 generates the frames 8a and 8b containing data of the client signals Ds (step St2). At this time, the transmission frame processor 260 notifies the time stamp adding unit 232 of the generation of the frames 8a and 8b.

Next, the time stamp adding unit 232 obtains the time from the time synchronization unit 231 in response to the generation notification to generate a time stamp (step St3), and adds the time stamp to the frames 8a and 8b (step St4). The frames 8a and 8b to which the time stamp is added are output to the optical transmitter 270. Next, the optical transmitter 270 transmits the frames 8a and 8b (step St5). In this manner, the transmission process of the frames 8a and 8b is executed.

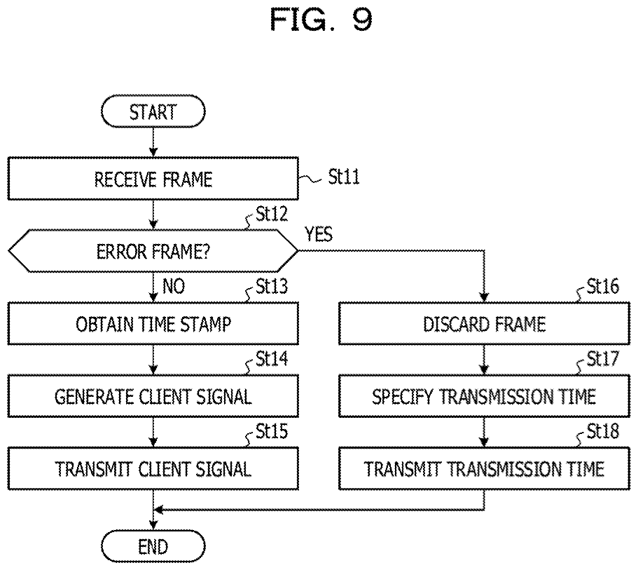

FIG. 9 is a flowchart illustrating an example of the reception process of the frames 8a and 8b. The optical receiver 271 receives the frames 8a and 8b (step St11). The frames 8a and 8b are converted into electric signals, and are output from the optical receiver 271 to the reception frame processor 261.

The reception frame processor 261 performs error detection processing on the frames 8 and 8b (step St12). A method for detecting an error is not limited, and may be a parity check, for example.

If no error is detected (No in step St12), the reception frame processor 261 obtains a time stamp from the overhead 81 of the frames 8a and 8b (step St3). The time stamp is output from the reception frame processor 261 to the time stamp detection unit 233. Furthermore, the frames 8a and 8b are output to the client IF 28.

Next, the client IF 28 generates the client signals Dr from the frames 8a and 8b (step St14), and transmits the signals to the client network (step St15).

Furthermore, if an error is detected (Yes in step St12), the reception frame processor 261 discards the error frames 8a and 8b (step St6). At this time, the reception frame processor 261 outputs error detection signals to the time stamp detection unit 233.

Next, the time stamp detection unit 233 specifies the transmission time of the error frames 8a and 8b from the transmission time indicated by the time stamp of the immediately preceding frames 8a and 8b (step St17). The time stamp detection unit 233 outputs the transmission time to the CPU 20.

The monitoring control IF 201 transmits the transmission time to the monitoring controller 1 via the communication port 24 (step St18). In this manner, the reception process of the frames 8a and 8b is executed.

Next, a process of measuring the fault position Q performed by the monitoring controller 1 will be described.

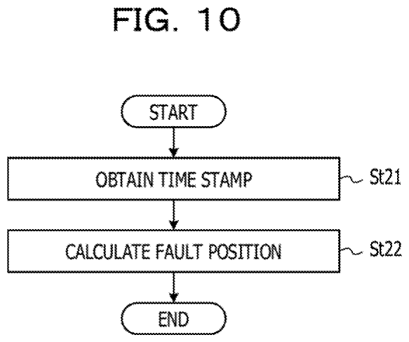

FIG. 10 is a flowchart illustrating an example of the process of measuring the fault position Q. The monitoring control unit 100 obtains the transmission times Tb and Ta from the transponders 2a and 2b (step St21).

Next, the measurement unit 101 calculates the fault position Q using the formulae (1) to (3) described above (step St22). In this manner, the process of measuring the fault position Q is executed.

### Other Examples

While the monitoring controller 1 measures the fault position Q in the example described above, one transponder 2a may measure a fault position Q by obtaining transmission time Ta from another transponder 2a. Since a monitoring controller 1 is unneeded in that case, a scale of a network system is reduced.

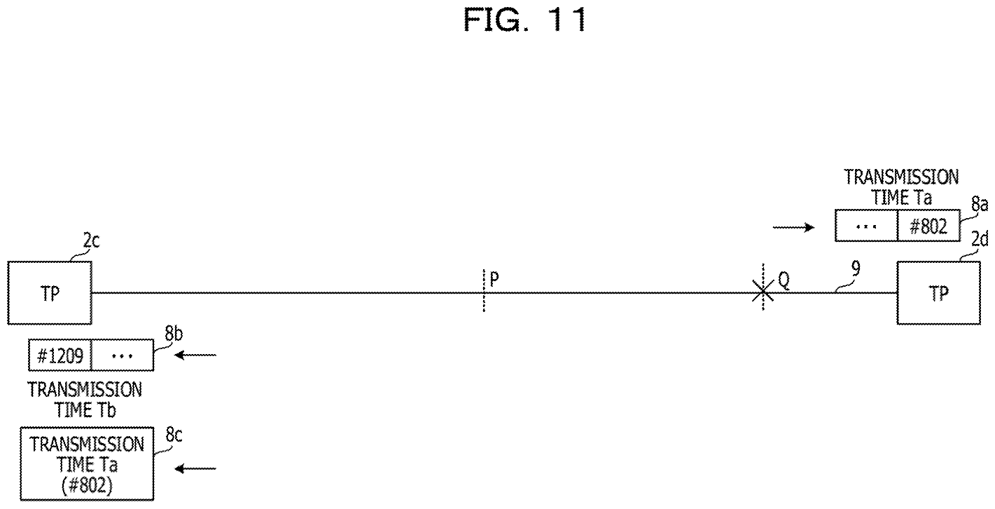

FIG. 11 is a diagram illustrating operation of transponders 2c and 2d according to another example. In a similar manner to transponders 2a and 2b, the transponders 2c and 2d add time stamps of transmission times Ta and Tb to frames 8a and 8b to be transmitted, and transmit the frames to the other transponders 2c and 2d via an optical transmission line 9. Note that the transponders 2c and 2d are examples of a first transmission device and a second transmission device, respectively.

However, unlike the transponders 2a and 2b, the transponders 2c and 2d do not notify the monitoring controller 1 of the transmission times Ta and Tb. One transponder 2d adds, to a control frame 8c, the transmission time Ta indicated by the time stamp added to the frame 8a received from the other transponder 2c, and transmits the control frame 8c to the transponder 2c via the optical transmission line 9. The transponders 2c and 2d measure the fault position Q from the transmission times Ta and Tb. Hereinafter, a configuration of the transponders 2c and 2d will be described.

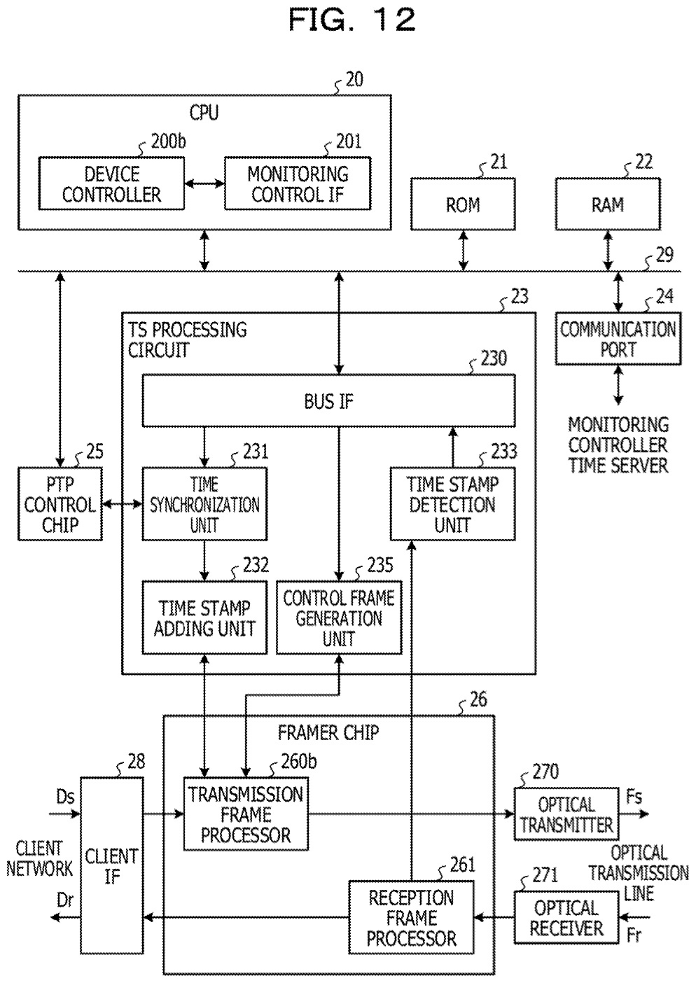

FIG. 12 is a configuration diagram illustrating a transponder 2d according to another example. In FIG. 12, the components same as those in FIG. 5 are denoted by the same reference signs, and descriptions thereof will be omitted.

A CPU 20 forms a device controller 200b instead of a device controller 200. The device controller 200b has a function similar to that of the device controller 200, and moreover, outputs transmission time Ta input from a time stamp detection unit 233 to a TS processing circuit 23 via a bus 29.

The TS processing circuit 23 includes a bus IF 230, a time synchronization unit 231, a time stamp adding unit 232, a time stamp detection unit 233, and a control frame generation unit 235. The control frame generation unit 235 receives the transmission time Ta from the device controller 200b via the bus IF 230. The control frame generation unit 235 generates a control frame 8c including the transmission time Ta.

The framer chip 26 includes a transmission frame processor 260b instead of a transmission frame processor 260. The transmission frame processor 260b has a function similar to that of the transmission frame processor 260, and moreover, outputs the control frame 8c to an optical transmitter 270. The transmission frame processor 260b notifies the control frame generation unit 235 of the transmittable timing of the control frame 8c, and the control frame generation unit 235 outputs the control frame 8c to the transmission frame processor 260b if there is the control frame 8c to be transmitted.

In this manner, the device controller 200b notifies another transponder 2c of the transmission time Ta added to a frame 8a in which an error has occurred among the frames 8a received by the optical receiver 271. Note that the device controller 200b is an example of a time notification unit.

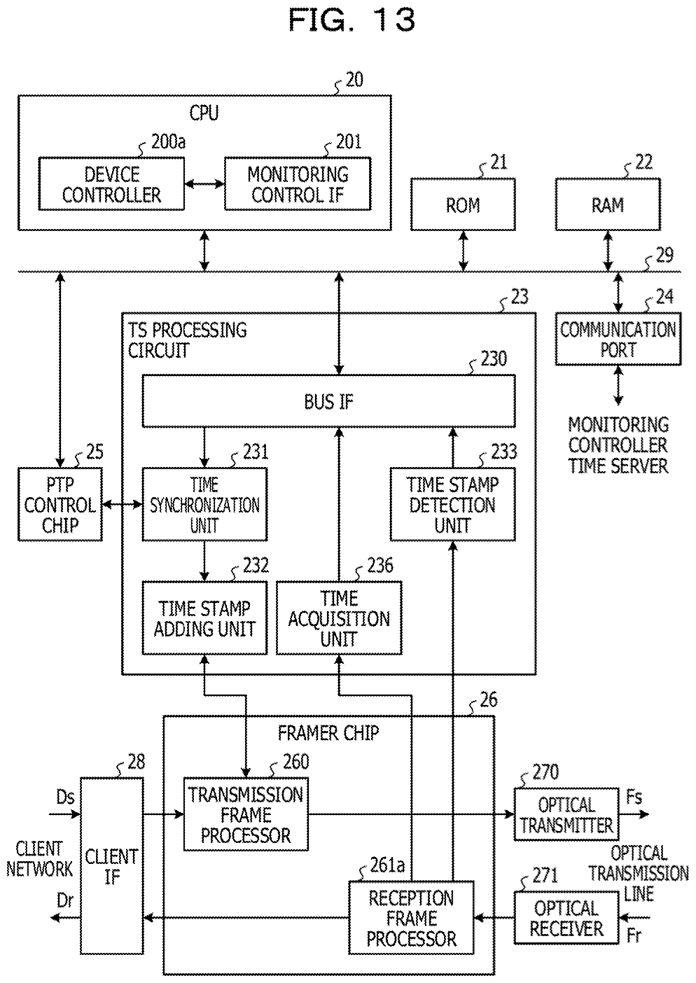

FIG. 13 is a configuration diagram illustrating a transponder 2c according to another example. In FIG. 13, the components same as those in FIG. 5 are denoted by the same reference signs, and descriptions thereof will be omitted.

A framer chip 26 includes a reception frame processor 261a instead of a reception frame processor 261. The reception frame processor 261a has a function similar to that of the reception frame processor 261, and moreover, outputs a control frame to a TS processing circuit 23.

The TS processing circuit 23 includes a bus IF 230, a time synchronization unit 231, a time stamp adding unit 232, a time stamp detection unit 233, and a time acquisition unit 236. The time acquisition unit 236 receives the control frame from the reception frame processor 261a.

The time acquisition unit 236 obtains transmission time Ta added to the control frame. The time acquisition unit 236 outputs the transmission time Ta to a CPU 20 via the bus IF 230 and a bus 29.

The CPU 20 forms a device controller 200a instead of a device controller 200. The device controller 200a has a function similar to that of the device controller 200, and moreover, measures a fault position Q from transmission times Ta and Tb.

The transmission time Ta of the error frame 8a is input to the device controller 200a from the time acquisition unit 236, and the transmission time Tb of the error frame 8b is input from the time stamp detection unit 233. The device controller 200a calculates the fault position Q from the transmission times Ta and Tb using the formulae (1) to (3) described above. Note that the device controller 200a transmits the fault position Q to a monitoring controller 1 via a communication port 24, for example. As a result, a user can know the fault position Q accordingly.

In this manner, the time acquisition unit 236 obtains the transmission time Ta added to the frame 8a in which the error has occurred among the frames 8a received by another transponder 2d. The device controller 200a measures the fault position Q at which the error of the frames 8a and 8b has occurred from the multiplied value of the difference between the transmission times Ta and Tb and a light speed Vc. Accordingly, the fault position Q can be easily measured in a similar manner to the example described above. Note that the device controller 200a is an example of a position measurement unit.

Next, a reception process of the frame 8a performed by the transponder 2d will be described. Note that a transmission process of the frame 8b performed by the transponder 2d is as illustrated in FIG. 8.

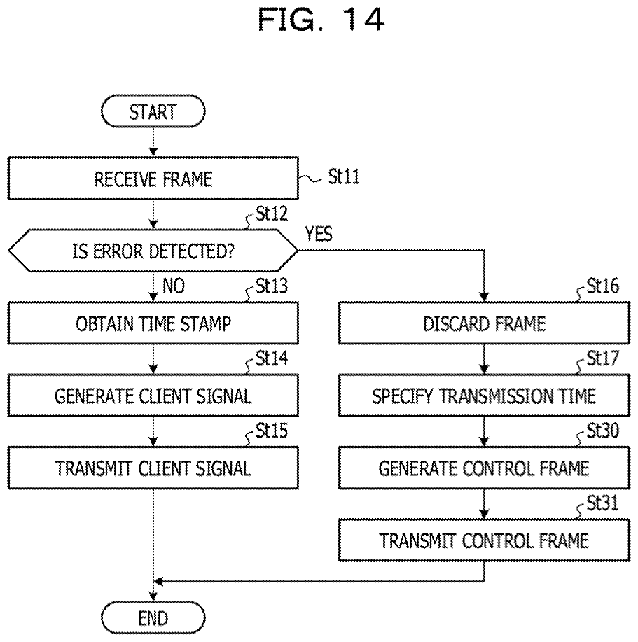

FIG. 14 is a flowchart illustrating an example of a reception process of a frame 8a performed by a transponder 2d according to another example. In FIG. 14, the processes same as those in FIG. 9 are denoted by the same reference signs, and descriptions thereof will be omitted.

After a time stamp detection unit 233 specifies transmission time Ta of an error frame 8a (step St17), a control frame generation unit 235 generates a control frame 8c including the transmission time Ta (step St30). The control frame 8c is output from a transmission frame processor 260b to an optical transmitter 270. The optical transmitter 270 transmits the control frame 8c to a transponder 2c (step St31). In this manner, the transponder 2d executes the reception process of the frame 8a.

Next, a reception process of a frame 8b performed by the transponder 2c will be described. Note that a transmission process of the frame 8a performed by the transponder 2c is as illustrated in FIG. 8.

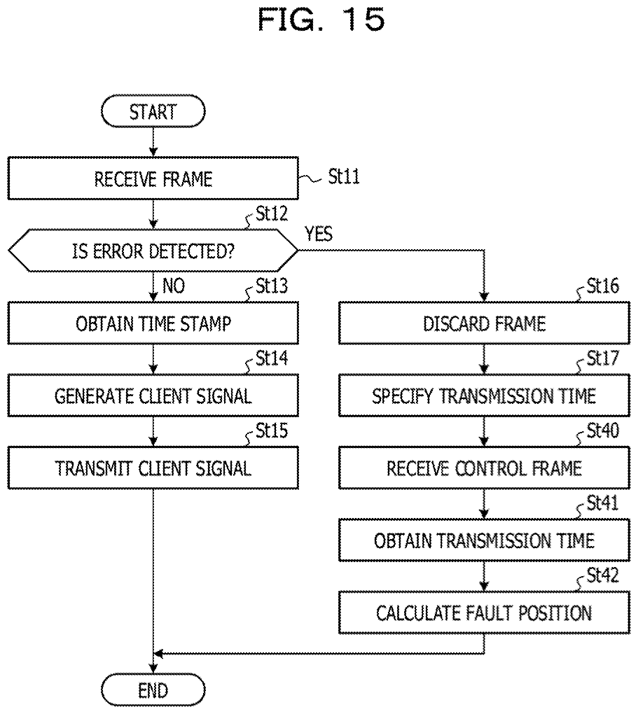

FIG. 15 is a flowchart illustrating an example of a reception process of a frame 8b performed by a transponder 2c according to another example. In FIG. 15, the processes same as those in FIG. 9 are denoted by the same reference signs, and descriptions thereof will be omitted. Note that each processing of steps St40 and St4 to be described below may be executed before steps St16 and St17.

After processing of step St17, an optical receiver 271 receives a control frame 8c from another transponder 2d (step St40). The control frame 8c is input to a reception frame processor 261a, and then input to a time acquisition unit 236.

Next, the time acquisition unit 236 obtains transmission time Ta of an error frame 8a from the control frame 8c (step St41). The transmission time Ta is output to a device controller 200a.

Next, the device controller 200a calculates a fault position Q from the transmission times Ta and Tb (step St42). In this manner, the transponder 2c executes the reception process of the frame 8b.

Note that, although an optical transmission line 9 includes two optical fibers 9a and 9b in each example described above, it may include only one optical fiber. In that case, bidirectional frames 8a and 8b are transmitted to a common optical fiber. Accordingly, in order to separate the frames 8a and 8b, a wavelength divisional multiplexing (WDM) coupler is provided between an optical transmitter 270 and an optical receiver 271 of each of transponders 2a to 2d and the optical fiber, for example. As a result, the transponders 2a to 2d can transmit and receive the frames 8a and 8b.

The embodiment described above is a preferred example. However, the embodiment is not limited thereto, and a variety of modifications may be made without departing from the scope of the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A measurement device that specifies an error occurrence position in a transmission line for connecting a first transmission device and a second transmission device, the measurement device comprising:
a memory; and
circuitry coupled to the memory and configured to:
obtain first time stamp information transmitted from the first transmission device and added to a first frame in which an error has occurred in the transmission line;
obtain second time stamp information transmitted from the second transmission device and added to a second frame in which an error has occurred in the transmission ine; and
specifies the error occurrence position in the transmission line on the basis of the first time stamp information, the second time stamp information, and a light speed, wherein
the first time stamp information is added to the first frame by the first transmission device in time synchronization with the second transmission device, and
the second time stamp information is added to the second frame by the second transmission device in time synchronization with the first transmission device.

2. The measurement device according to claim 1, wherein
the first frame and the second frame are transmitted to the transmission line at a same transmission speed.

3. The measurement device according to claim 1, wherein
the light speed is a propagation speed of light in the transmission line.

4. A first transmission device connected to a second transmission device via a transmission line, the first transmission device comprising:
signal processing circuitry configured to add first time stamp information to a first frame in time synchronization with the second transmission device;
a transmitter configured to transmit the first frame to which the first time stamp information is added to the second transmission device via the transmission line;
a receiver configured to receive, from the second transmission device, a second frame including second time stamp information added by the second transmission device in time synchronization with the first transmission device; and
an interface configured to, in a case where an error has occurred in the second frame, make notification of the second time stamp information added to the second frame in which the error has occurred.

5. The first transmission device according to claim 4, wherein
the first time stamp information is added to an overhead of the first frame.

6. The first transmission device according to claim 4, further comprising:
a processor configured to:
obtain the first time stamp information added to, among a plurality of the first frames received by the second transmission device, the first frame in which an error has occurred; and
specify a position of the transmission line at which the error has occurred in the first frame and the second frame on the basis of the second time stamp information added to the second frame in which the error has occurred, the obtained first time stamp information, and a light speed.

7. A network system comprising:
a first transmission device;
a second transmission device connected to the first transmission device via a transmission line; and
a measurement device that specifies a position at which an error has occurred in a frame transmitted in the transmission line, wherein
the first transmission device is configured to:
add first time stamp information to a first frame in time synchronization with the second transmission device;
transmit the first frame to which the first time stamp information is added to the second transmission device via the transmission line;
add second time stamp information to a second frame in time synchronization with the first transmission device; and
transmit the second frame to which the second time stamp information is added to the first transmission device via the transmission line,
the first transmission device is further configured to:
receive the second frame from the second transmission device via the transmission line; and
in a case where an error has occurred in the received second frame, notify the measurement device of the second time stamp information included in the second frame in which the error has occurred,
the second transmission device is configured to:
receive the first frame from the first transmission device via the transmission line; and
in a case where an error has occurred in the received first frame, notify the measurement device of the first time stamp information included in the first frame in which the error has occurred, and
the measurement device is configured to specify the position at which the error has occurred on the basis of the second time stamp information notified from the first transmission device, the first time stamp information notified from the second transmission device, and a light speed.

8. A network system comprising:
a first transmission device; and
a second transmission device connected to the first transmission device via a transmission line, wherein
the first transmission device is configured to:
add first time stamp information to a first frame in time synchronization with the second transmission device;
transmit the first frame to which the first time stamp information is added to the second transmission device via the transmission line;
add second time stamp information to a second frame in time synchronization with the first transmission device; and
transmit the second frame to which the second time stamp information is added to the first transmission device via the transmission line,
the first transmission device is further configured to:
receive the second frame from the second transmission device via the transmission line; and
in a case where an error has occurred in the received second frame, notify the second transmission device of the second time stamp information included in the second frame in which the error has occurred, and
the second transmission device is configured to:
receive the first frame from the first transmission device via the transmission line; and
on the basis of the first time stamp information included in the first frame in which an error has occurred in a case where the error has occurred in the received first frame, the second time stamp information notified from the first transmission device, and a light speed, specify a position at which the error has occurred.
